(19) United States
(12) Patent Application Publication
(10) Pub. No.: US 2013/0040199 A1
(43) Pub. Date: Feb. 14, 2013

(54) METHOD FOR MANUFACTURING ELECTRODE ACTIVE MATERIAL

(71) Applicant: Hideyuki Yamamura, Susono-shi (JP)

(72) Inventor: Hideyuki Yamamura, Susono-shi (JP)

(21) Appl. No.: 13/643,123

(22) PCT Filed: Apr. 26, 2010
(86) PCT No.: PCT/JP2010/057368

§ 371 Date: Oct. 24, 2012

(51) Int. Cl. H01M 4/134; B05D 5/12

(52) U.S. Cl. 429/218.1; 427/122

(57) ABSTRACT

In the method for manufacturing a particulate electrode active material provided by the present invention, a compound comprising phosphorus or boron is added to a mixed material prepared by mixing a carbon source supply material prepared by dissolving a carbon source (102) in a predetermined first solvent and an electrode active material supply material prepared by dispersing a particulate electrode active material (104) in a second solvent which is a poor solvent with respect to the carbon source, and a mixture of the electrode active material particles and the carbon source obtained after the addition is calcined, thereby producing a particulate electrode active material in which a conductive carbon coat derived from the carbon source is formed on the surface.

### TECHNICAL FIELD

The present invention relates to a method for manufacturing an electrode active material for use in a lithium secondary battery or other battery. The present invention also relates to an electrode active material manufactured by the aforementioned method and the use thereof.

### BACKGROUND ART

The importance of secondary batteries such as lithium secondary batteries (typically, lithium ion batteries) and nickel hydride batteries as power supplies for vehicles or power supplies for personal computers and portable terminals has grown in recent years. In particular, lithium secondary batteries that make it possible to obtain a high energy density with a light weight are expected to be advantageously used as high-output power supplies for vehicles.

The increased battery capacity is one of the characteristics that are required for secondary batteries to be used as high-output power supplies for vehicles. The use of substances that can realize a capacity higher than that of the conventional devices as electrode active materials has been investigated as a means for fulfilling such a requirement. For example, metal compound (typically, metal oxide) materials that use Si, Ge, Sn, Pb, Al, Ga, In, As, Sb, Bi, or the like as the constituent metal elements (including semi-metallic elements; same hereinbelow) can be used in lithium secondary batteries as electrode active materials (more specifically, negative electrode active materials) that reversibly absorb and desorb lithium ions, and such materials are known to have a capacity higher than that of the graphite materials that have been conventionally used as negative electrode active materials. Therefore, it can be expected that by using such metal compounds (typically, metal oxides) as electrode active materials, it would be possible to realize an increased capacity of lithium secondary batteries.

However, metal compound materials (for example, metal oxide materials such as silicon oxide (SiOₓ)) using the elements, such as described above, as the constituent elements typically have a low electric conductivity. Therefore when such metal oxides are used as electrode active materials, it is necessary that a conductive coat, more specifically, a coat constituted by conductive carbon, be formed on the surface of the electrode active material constituted by the metal oxide, or that electrode active material particles constituted by composite particles including the metal oxide and electrically conductive carbon be fabricated, so as to ensure electrically conductive paths in which lithium ions or electrons could move between the electrode active material particles or between the electrode active material particles and the electrolytic solution or electrode collector.

Examples of the conventional techniques relating to electrode active materials using silicon or silicon oxide as the above-mentioned metal oxide materials are disclosed in the following Patent Literatures 1 to 3. Patent Literature 1 describes an electrode active material in which the surface of composite particles constituted by Si, SiO and SiO₂, and a carbonaceous material is covered with carbon. Patent Literature 2 describes an electrode active material including particles consisting of a carbonaceous material and a silicon oxide dispersed in the carbonaceous material, and in the composite particles a silicon phase and a metal phase (the metal phase includes Ni or Cu) are dispersed in a silicon oxide. Patent Literature 3, which does not directly relate to the invention of the present application, describes a negative electrode material (negative electrode active material) including as a main component a polycrystalline silicon powder constituted by single crystal silicon particles doped with phosphorus and boron as dopants.

### CITATION LIST

### Patent Literature

Patent Literature 1: Japanese Patent Application Publication No. 2006-092969
Patent Literature 2: Japanese Patent Application Publication No. 2007-042393
Patent Literature 3: Japanese Patent Application Publication No. 2003-109590

However, with the conventional techniques such as described in the aforementioned patent literature, since the above-described electrode active materials can expand and contract in the charge-discharge cycles, carbon-carbon bonds in the carbonaceous material or carbon coat that can form conductive paths in the electrode active material are easily broken. As a result, in a battery using such an electrode active material, where charge and discharge cycles are repeated, the initial capacity cannot be maintained and a battery demonstrating an excellent cycle characteristic (capacity retention ratio) is difficult to realize.

### SUMMARY OF INVENTION

The present invention was created to resolve this problem and it is an object thereof to provide a method capable of forming efficiently a carbon coat on metal compound particles (primary particles) such as SiOₓ that can become an electrode active material realizing an increased battery capacity and an improved cycle characteristic. Another object of the present invention is to provide a method for manufacturing electrode active material particles of a preferred mode in which the desirable carbon coat is formed by implementing the aforementioned method for forming the carbon coat. Yet another object of the present invention is to provide a lithium secondary battery and other battery realizing an increased capacity that is provided with the particulate electrode active material (more specifically, a negative electrode active material and/or a positive electrode active material) manufactured by the aforementioned manufacturing method.

The present invention provides a method for manufacturing an electrode active material of the following embodiments.

Thus, one of the manufacturing methods disclosed herein is a method for manufacturing a particulate electrode active material having a surface covered with a conductive carbon coat. This method includes:

(1) preparing a carbon source supply material prepared by dissolving a carbon source for forming the carbon coat in a predetermined first solvent in which the particulate electrode active material, which is the object of coating, can be dispersed;

(2) preparing an electrode active material supply material prepared by dispersing the particulate electrode active material, which is the object of coating, in a second solvent that is compatible with the first solvent, that allows the particulate electrode active material to be dispersed therein, and that is a poor solvent with respect to the carbon source;

(3) preparing a mixed material in which the prepared carbon source supply material and electrode active material supply material are mixed;

(4) adding a compound including phosphorus (P) or boron (B) to the prepared mixed material; and

(5) forming a conductive carbon coat derived from the carbon source on a surface of the electrode active material by calcining a mixture of the electrode active material particles and the carbon source obtained after the addition.

The specific feature of the particulate electrode active material manufacturing method of the abovementioned configuration is that a carbon source supply material prepared by dissolving a carbon source for forming a carbon coat in the first solvent is mixed with an electrode active material supply material prepared by dispersing in a solvent that is different from the first solvent and is a poor solvent with respect to the carbon source (that is, a solvent with a relatively low solubility of the carbon source, typically a poor solvent in which the solubility of the carbon source is equal to or less than 1/10, preferably equal to or less than 1/100 that in the first solvent, when the solubility is compared at the same temperature (for example, in a room temperature range of 20 to 30° C.)), and then a compound including phosphorus or boron is added to the mixed material.

In a mixed solvent in which the first solvent and the second solvent produced by mixing the aforementioned two materials are present in a mixture (mutually dissolved), the carbon source is present substantially only in the first solvent component and is unlikely to be present in the second solvent (poor solvent) component. Meanwhile, the particulate electrode active material can flow and be dispersed in either of the first and second solvents. In other words, when the dispersed electrode active material particles that freely move between the first and second solvent components in the abovementioned mixed solvent are present in the first solvent component, the electrode active material particles interact with the carbon source present in this solvent. Typically, the carbon source is bonded or adheres to the surface of the electrode active material particles. The movement of the electrode active material particles (typically, the electrode active material particles having the carbon source bonded or adhered to the surface thereof) that have interacted with the carbon source from the first solvent to the second solvent is controlled by the presence of the carbon source that has interacted therewith. Therefore, in the mixed solvent in which the abovementioned first solvent component and second solvent component are present in a mixture, the carbon source can be efficiently caused to interact with (to adhere or be bonded to) the dispersed electrode active material particles and excessive aggregation of the electrode active material particles with each other is inhibited.

Further, with the manufacturing method disclosed herein, the above-mentioned compound including phosphorus or boron is added to the mixed material, and the mixture of the above-mentioned electrode active material particles and carbon source obtained after the mixing is calcined under the predetermined conditions.

With the manufacturing method disclosed herein, where a compound including phosphorus or boron is added to the abovementioned mixed material, a carbon coat with increased bonding strength between carbon atoms that can form electrically conductive paths can be formed on the surface of primary particles of the electrode active material after the calcination of the mixed material due to the presence of phosphorus or boron, while maintaining the interaction (adhesion or bonding) of the dispersed electrode active material particles and carbon source in the mixed material.

Therefore, with the manufacturing method disclosed herein, it is possible to manufacture a particulate electrode active material in which a carbon coat with strong carbon-carbon bonds can be effectively (that is, in a state with only few portions where the coat is not formed) formed on the surface of primary particles and an excellent cycle characteristic can be realized.

In the preferred embodiment of the manufacturing method disclosed herein, when the compound including phosphorus or boron is added to the mixed material, the compound is provided at least in the form of a solution obtained by being dissolved in a liquid solvent compatible with the above-mentioned first solvent. Where the compound including phosphorus or boron is added in the form of such a solution, the compound is easily dissolved by the mixed material (strictly speaking, by the above-mentioned first solvent component contained in the mixed material), and phosphorus or boron uniformly and easily diffuse in the mixed material. As a result, phosphorus or boron can uniformly come into contact with carbon atoms present in the first solvent component and can strengthen the carbon-carbon bonds in the carbon source. Therefore, with the manufacturing method of such a configuration, it is possible to manufacture a homogeneous particulate electrode active material provided with a carbon coat with strong carbon-carbon bonds.

In the preferred embodiment of the manufacturing method disclosed herein, at least one type of inorganic phosphoric acid is used as the compound including phosphorus. In another preferred embodiment, at least one type of inorganic boric acid is used as the compound including boron. The inorganic phosphoric acids as referred to herein is a general name of inorganic compounds having a phosphoric acid skeleton including a phosphorus atom with an oxidation number of +5 and an oxygen atom with an oxidation number of −2, and orthophosphoric acid (H₃PO₄), pyrophosphoric acid (also called diphosphoric acid; H₄P₂O₇), higher condensed phosphoric acid (Hₙ₊₂PₙO₃ₙ₊₁), and metaphosphoric acid (also called polyphosphoric acid; (HPO₃)ₙ) are included in the inorganic phosphoric acids referred to herein. Examples of the inorganic boric acids include orthoboric acid (H₃BO₃), hypoboric acid (H₄B₂O₄), boric acid (H₃BO₂), perboric acid (HBO₃), and metaboric acid ((HBO₂)ₙ).

Where such compounds are used, the effect of strengthening the bonding of carbon atoms in the carbon source is advantageously further improved and it is possible to manufacture an effective particulate electrode active material having formed thereon a carbon coat with strong carbon-carbon bonds.

Advantageous examples of the particulate electrode active material that is the object of coating with the carbon coat and can be advantageously used in the method for manufacturing an electrode active material disclosed herein include metal compounds (preferably, metal oxides) having Si, Ge, Sn, Pb, Al, Ga, In, As, Sb, Bi, or the like as constituent metal elements. By using those metal compounds as negative electrode active materials of lithium secondary batteries, it is possible to provide a lithium secondary battery that demonstrates a capacity higher than that of a lithium ion battery using, for example, conventional graphite as a negative electrode active material.

In yet another preferred embodiment of the manufacturing method disclosed herein, the electrode active material is mainly constituted by a silicon oxide represented by a general formula SiOₓ (x in the formula is a real number satisfying the condition 0<x<2). The silicon oxide of this kind has a high theoretic capacity relating to absorption and desorption of lithium ions and can be advantageously used, for example, as a negative electrode active material of a lithium secondary battery.

The electrode active material constituted by the abovementioned oxide or a compound (typically, a metal oxide) of another of the above-described metal species expands or contracts following the absorption or desorption of lithium ions during charging and discharging, and the volume thereof changes significantly. In this case, in the active material in which a carbon coat is formed only on the surface of secondary particles (that is, aggregates of primary particles), as described hereinabove, the secondary particles are broken by stresses caused the abovementioned expansion and contraction. As a result, a granular material is produced that has a surface where the carbon coat is not formed. The abovementioned silicon oxide or other metal compound on which the carbon coat is not formed does not have conductive paths created by the carbon coat and makes no contribution as an electrode active material to the increase in battery capacity. Another undesirable result is that battery durability, in particular cycle characteristic, is degraded.

By contrast, with the manufacturing method disclosed herein, a carbon coat with strong carbon-carbon bonds can be efficiently formed on the surface of primary particles. Therefore, even though the active material expands or contracts following the absorption and desorption of lithium ions and the volume thereof changes significantly, a granular matter (crushed secondary particles) having the surface where the carbon coat has not been formed is unlikely to appear. Furthermore, bonds between carbon atoms of the carbon coat are unlikely to be broken and therefore conductive paths are effectively maintained. Therefore, it is possible to provide an electrode active material with a carbon coat that is suitable for constructing a battery that maintains a high capacity with good stability and also excels in a cycle characteristic.

In yet another preferred embodiment of the method for manufacturing an electrode active material disclosed herein, the carbon source is a water-soluble compound, the first solvent is an aqueous solvent (typically, water), and the second solvent is a nonaqueous solvent that is compatible with water (for example, a polar solvent such as ethanol that can be mixed with water at a desired mixing ratio).

By using the first solvent and the second solvent in such a combination, it is possible to manufacture a particulate electrode active material in which the carbon coat is formed more effectively on the surface of primary particles.

In yet another preferred embodiment of the method for manufacturing an electrode active material disclosed herein, the mixed material is subjected to reflux processing before the addition of the compound including phosphorus or boron.

By performing the reflux processing (typically, the reflux processing is performed in a temperature range in which a solvent of a mixed material can be boiled) with respect to the mixed material before the addition of the compound including phosphorus or boron, it is possible to disperse the particulate electrode active material more advantageously in the mixed material. Therefore, the carbon coat with strong carbon-carbon bonds can be formed more efficiently and more uniformly on the surface of the electrode active material.

The present invention also provides a lithium secondary battery in which the electrode active material disclosed herein (typically, the negative electrode active material formed of the metal compound manufactured by any of the manufacturing methods disclosed herein) is included in a positive electrode or a negative electrode.

Because the lithium secondary battery disclosed herein is provided with the abovementioned electrode active material, an increased capacity and good electric conductivity can be realized. Therefore, such a battery demonstrates performance particularly suitable for a battery to be installed on a vehicle that requires high-rate charging and discharging.

Therefore, in accordance with the present invention, a vehicle is also provided that includes the lithium secondary battery disclosed herein. In particular, a vehicle (for example, an automobile) is provided that includes the lithium secondary battery as a power supply (typically a power supply of a hybrid vehicle or an electric automobile).

### BRIEF DESCRIPTION OF DRAWINGS

FIG. 1 is a perspective view illustrating schematically a battery pack according to an embodiment of the present invention.

FIG. 2 is a front view illustrating schematically an example of a wound electrode body.

FIG. 3 is a cross-sectional view illustrating schematically the configuration of a unit battery provided in the battery pack.

FIG. 4 is a side view illustrating schematically a vehicle equipped with a lithium secondary battery.

FIG. 5 is an explanatory drawing illustrating schematically the state (aggregation state of electrode active material particles) in which a carbon source and a particulate electrode active material are together added to the conventional single solvent.

FIG. 6 is an explanatory drawing illustrating schematically the presence state of the carbon source and particulate electrode active material in a mixed material (material prepared by mixing the first solvent and the second solvent) obtained by the manufacturing method disclosed herein.

FIG. 7 shows a polygonal line graph illustrating the correlation between the number of cycles (cycles) and Li introduction capacity (mAh/g) in a cycle test of estimation cells (metallic lithium is a counter electrode) constructed by using Samples 1 to 5 obtained in the below-described examples as electrode active materials.

FIG. 8 shows a bar graph (see the left ordinate) illustrating the amount of carbon (wt %) in mixed materials of Samples 1 to 5 obtained in the below-described examples, and a polygonal line graph (see the right ordinate) illustrating the capacity retention ratio (%) obtained in a cycle test using the estimation cells (metallic lithium is a counter electrode) constructed by using the abovementioned samples as electrode active materials.

FIG. 9 shows a polygonal line graph illustrating the capacity retention ratio (%) obtained in a cycle test using the estimation cell (metallic lithium is a counter electrode) constructed by using Sample 6 obtained in below-described example as an electrode active material.

### DESCRIPTION OF EMBODIMENTS

Preferred embodiments of the present invention are explained below. Any features other than the features specifically set forth in the present description and which may be necessary for carrying out the present invention can be regarded as design matters for a person skilled in the art, those matters being based on the conventional techniques in the pertinent technical field. The present invention can be carried out on the basis of the disclosure of the present description and common technical knowledge in the pertinent technical field.

In the present description, “electrode active material” is a term inclusive of a positive electrode active material that is used at a positive electrode side and a negative electrode active material that is used at a negative electrode side. An active material as referred to herein is a substance (compound) participating in accumulation of electric charges at a positive electrode side or negative electrode side. Thus, the active material is a substance taking part in release and intake of electrons when a battery is charged and discharged.

Further, in the present description, “lithium secondary battery” is a battery in which transfer of electric charges is performed by lithium ions in an electrolyte. So-called lithium ion battery (or lithium ion secondary battery) and a battery called lithium polymer battery are typical examples of batteries covered by “lithium secondary battery” term used herein.

With the manufacturing method disclosed herein, it is possible to manufacture a particulate electrode active material having a surface formed with a conductive carbon coat in which carbon atoms are strongly bonded to each other, as mentioned hereinabove.

The manufacturing method disclosed herein makes it possible to cover efficiently the surface of electrode active material particles (that is, primary particles) that have a low electric conductivity with a conductive carbon coat having strong carbon-carbon bonds.

An active material that can be dispersed at least in the abovementioned first solvent and second solvent and can be made suitable for forming a conductive carbon coat derived from a carbon source on the surface thereof by calcining may be used as a particulate electrode active material that is the object of performing the aforementioned coating. For example, various metal compounds (for example, metal oxides) advantageous as negative electrode active materials for lithium secondary batteries, for example, metal compounds (preferably, metal oxides) having Si, Ge, Sn, Pb, Al, Ga, In, As, Sb, Bi or the like as constituent metal elements can be used. In particular, a silicon oxide such as specified by the above-mentioned formula can be advantageously used. Furthermore, various lithium—transition metal composite oxides (for example, LiCoO₂, LiNiO₂, and LiMn₂O₄) that can be used as positive electrode active materials of lithium secondary batteries can be used.

For example, a polyanion compound represented by a general formula LiMAO₄ can be used. M in this formula is typically one, or two or more elements (typically one, or two or more metal elements) including at least one metal elements selected from the group consisting of Fe, Co, Ni, and Mn. Thus, at least one metal element selected from the group consisting of Fe, Co, Ni, and Mn is included, but the presence of a minor additional element that can be contained in a small amount is also allowed (such minor additional element may be absent). Further, in the abovementioned formula, A is typically one, or two or more elements selected from the group consisting of P, Si, S, and V.

Typically, a particulate electrode active material with an average particle size (for example, a median diameter: d50 determined by a light scattering method or an average particle size determined by microscopic observations) of about 10 nm to 10 μm (typically, 100 nm to 5 μm, for example, from 100 nm to 1000 ma) can be preferably used.

A particularly advantageous specific example of an electrode active material is a silicon oxide represented by the general formula SiOₓ. In this formula, x is typically a real number satisfying the condition of 0<x<2, and preferably can be about 0<x<0.6. A particulate material formed of a commercially available silicon oxide such as SiO can be advantageously used.

By using such silicon oxide as a negative electrode active material, it is possible to obtain a lithium secondary battery that has a particularly high charge-discharge capacity. Further, with a negative electrode active material for a lithium secondary battery formed of such a metal oxide, the active material expands by itself when lithium ions are absorbed during charging and discharging and, conversely, the active material contracts by itself when lithium ions are released. Therefore, structural changes of a negative electrode active material structure (that is, a layered configuration formed on the surface of a negative electrode collector, typically of copper, by secondary particles obtained by aggregation of primary particles) present in a negative electrode of a battery can easily occur, and a conductive carbon coat should be formed in advance to a sufficient extent on the surface of the primary particles constituting the aforementioned negative electrode active material structure in order to maintain a high electric conductivity in the negative electrode active material structure after such structural changes. By implementing the manufacturing method disclosed herein, it is possible to form efficiently a sufficient conductive carbon coat on the surface of primary particles of the electrode active material having such properties.

In the usual state. H groups (typically Si—O—H or Si—H) are often present on the surface of particles of silicon oxide such as silica. Because of the presence of such H groups (H atoms), for example, when a water-soluble compound is used as a carbon source, hydrogen bonds, covalent bonds, or the like can be generated between groups of silicon oxide particles and highly electronegative portions (for example, portions of —OH groups) present in the compound, and strong interaction can occur. Therefore, by selecting an appropriate first solvent and second solvent, it is possible to apply easily a carbon source such as a water-soluble compound to the surface of silicon oxide particles.

A carbon source that can be thermally decomposed when calcined together with an electrode active material particles, thereby forming a conductive carbon coat (carbon structure), and can be dissolved at least in an appropriate solvent can be used as a carbon source for forming a conductive carbon coat on the surface of an electrode active material particles constituting a metal compound such as the abovementioned silicon oxide.

For example, a water-soluble organic compound (in particular, a polymer compound such as a water-soluble polymer) that has poor solubility in a predetermined organic solvent (that is, this organic solvent corresponds to a poor solvent) can be advantageously used.

The preferred examples of such organic compounds include water-soluble polymer compounds (polymers) such as polyvinyl alcohol (PVA). PVA has a large number of hydroxyl groups (—OH) in a molecular chain, and because of the presence of hydroxyl groups, the desirable interaction (for example, chemical bonding such as hydrogen bonding, covalent bonding, and ion bonding, and physical bonding such as adsorption) easily occur with electrode active material particles. Another merit of polyvinyl alcohol is that thermal decomposition thereof under oxidizing conditions in the air can result in the formation of a carbon coat demonstrating good electric conductivity. Examples of water-soluble polymer compounds, other than PVA, that can be used as a carbon source include starch, gelatin, cellulose derivatives such as methyl cellulose and carboxymethyl cellulose, polyacrylic acid, polyacrylamide, polyethylene oxide, polyethylene glycol, polymethacrylic acid and polyvinylpyrrolidone.

According to the manufacturing method disclosed herein, a compound including phosphorus or boron is added to the mixed material of an electrode active material and a carbon source in order to form a conductive carbon coat having strong carbon-carbon bonds on the surface of the electrode active material particles. It is preferred that such a compound be soluble in the carbon source supply material (strictly speaking, the first solvent) or be soluble in a liquid medium compatible with the carbon source supply material. For example, in the case where the first solvent is an aqueous solvent, an inorganic phosphoric acid can be advantageously used as the compound including phosphorus. The preferred compound is orthophosphoric acid (H₃PO₄), pyrophosphoric acid (H₄P₂O₇), condensed phosphoric acid Hₙ₊₂PₙP₃ₙ₊₁), and metaphosphoric acid ((HPO₃)ₙ). At least one of such inorganic phosphoric acids can be used. For example, orthophosphoric acid that has high utility and is easy to obtain can be used particularly advantageously.

As for the compound including boron, similarly to the compound including phosphorus, it is preferred that the compound be soluble in the carbon source supply material or in a liquid medium compatible with the carbon source supply material. For example, in the case where the first solvent is an aqueous solvent, an inorganic boric acid can be advantageously used. Examples of the preferred compounds include orthoboric acid (H₃BO₃), hypoboric acid (H₄B₂O₄), boronic acid (H₃BO₂), perboric acid (HBO₃), and metaboric acid (HBO₂)ₙ). It is preferred that at least one of those acids be used. Typically, orthoboric acid can be especially advantageously used.

The preferred embodiment of the manufacturing method disclosed herein in Which a particulate electrode active material and carbon source (material for forming a carbon coat) such as described hereinabove are used will be explained hereinbelow.

A carbon source supply material that is used in the manufacturing method disclosed herein is prepared by dissolving a predetermined carbon source (only one type of carbon source may be used or a combination of carbon sources of two or more types may be used) in an appropriate amount in a first solvent capable of dissolving the carbon source. For the sake of convenience, the first solvent (solvent for preparing the carbon source supply material) will be referred to as “first solvent”. The first solvent may be formed of an individual substance (molecular species) or by a mixed medium of a plurality of substances (molecular species). The first solvent can be selected according to the carbon source to be used. For example, when a water-soluble organic substance such as PVA is used as the carbon source, an aqueous solvent capable of advantageously dissolving such a compound is preferred. Typically, water (inclusive of distilled water and deionized water) can be used as the first solvent.

The concentration of the carbon source in the carbon source supply material (that is, the carbon source solution) is not particularly limited, but the content that can be entirely dissolved (namely, the concentration lower than that of the saturated solution obtained with the solvent) is preferred. Not particularly limited, but, for example, in the case of a water-soluble compound such as PVA, an aqueous solution such that the concentration of the water-soluble compound is about 0.1 to 20 wt % (for example, about 0.3 to 15 wt %, preferably 1 to 15 wt %, and more preferably about 1 to 10 wt %), where the total carbon source supply material is taken as 100 wt %, can be advantageously used as the carbon source supply material. For example, an aqueous PVA solution prepared by adding about 1 g to 1.00 g (preferably, about 10 g to 100 g) of PVA to 1 liter (L) of water is an advantageous example of the carbon source supply material. When the carbon source supply material is prepared, various stirring and mixing means can be used to dissolve completely a carbon source. For example, stirring by vibrations caused by ultrasonic waves can be performed or a magnetic stirrer can be used.

The carbon source supply material may also include components other than the above-described first solvent and carbon source, provided that the object of the present invention is still attained. Examples of suitable additional components include a pH adjusting agent, a surfactant, a preservative, a colorant, and so on.

Meanwhile, a particulate electrode active material supply material that is used in the manufacturing method disclosed herein is prepared by dispersing an appropriate amount of a predetermined particulate electrode active material in a second solvent capable of dispersing the particulate electrode active material. Similarly to the first solvent, for the sake of convenience, the aforementioned second solvent will be referred to as “second solvent”. The second solvent may be formed of an individual substance (molecular species) or by a mixed medium of a plurality of substances (molecular species).

In addition to the capability of dispersing a particulate electrode active material that is to be used, the second solvent is required to be compatible with the first solvent and be a poor solvent with respect to a carbon source to be used. For example, when a water-soluble organic substance (typically, a water-soluble polymer) such as PVA, polyacrylic acid, and polyethylene glycol etc. is dissolved in water as the first solvent and the solution obtained is used as the carbon source supply material, an organic solvent that is compatible with water and is unlikely to dissolve the carbon source (the solubility of the carbon source is extremely low) can be advantageously used as the second solvent. For example, alcohols that are poor solvents with respect to PVA, for example, lower alcohols with a number of carbon atoms equal to or less than four, such as readily water-soluble methanol, ethanol, isopropanol, and 2-methyl-2-butmol can be advantageously used as the second solvent. Thus, a person skilled in the art understands that where a carbon source to be used is determined, any solvent that is well known to be a poor solvent with respect to the determined carbon source may be selected as appropriate.

Further, the concentration (content ratio) of the electrode active material in the electrode active material supply material (that is, a dispersion or suspension including the active material source in a dispersed state) is not particularly limited. For example, in the case of silicon oxide such as SiOₓ or other metal oxides described hereinabove, a dispersion with a content ratio of the particulate electrode active material of about 0.5 to 20 wt % (preferably about 1 to 20 wt %, for example about 1 to 15 wt %, more preferably 1 to 10 wt %, for example about 5 to 10 wt %), where the total electrode active material supply material is taken as 100 wt %, can be advantageously used as the electrode active material supply material. For example, a dispersion (or suspension) prepared by adding about 10 g to 100 g (for example, 50 g to 90 g) of silicon oxide to 1 liter (L) of a lower alcohol with high solubility in water, such as ethanol, this content ratio being about the same as that of the carbon source in the carbon source supply material that is mixed with the electrode active material supply material, is an advantageous example of the electrode active material supply material.

The electrode active material supply material may also include components other than the above-described second solvent and particulate electrode active material, provided that the object of the present invention is still attained. Examples of suitable additional components include a conductive aid typically formed of a carbon material such as carbon black, a dispersant, a pH adjusting agent, a surfactant, a preservative, a colorant and so on. For example, it is preferred that a conductive aid (for example, a finely powdered conductive carbon material such as carbon black) be added in an amount corresponding to 1 to 20 wt % of the total amount of the electrode active material formed of silicon oxide such as SiOₓ or other metal compounds (oxides or the like) described hereinabove.

In the manufacturing method disclosed herein, a mixed material is prepared by mixing at a predetermined ratio a carbon source supply material and electrode active material supply material prepared in the above-described manner. In this case, since the second solvent (derived from an electrode active material supply material) is a poor solvent with respect to a carbon source included in the carbon source supply material, the carbon source (typically, an organic substance) is unlikely to be present in the second solvent (poor solvent) component and is present substantially only in a first solvent component. Meanwhile, the particulate electrode active material can flow in both the first solvent and the second solvent. Therefore, when the dispersed electrode active material particles that can freely move between the first and second solvent components in the mixed solvent are present in the first solvent component, those particles interact with the carbon source present in this solvent. For example, when a carbon source is a compound having a polar group (for example, PVA having a large number of hydroxyl groups in a molecular chain) and the particulate electrode active material is provided, with a polar group (for example, a hydrogen atom present on the surface of SiO) on the surface, the desirable interaction with the electrode active material particles (for example, chemical bonding such as hydrogen bonding, covalent bonding, and ion bonding, or physical bonding such as adsorption) easily occurs due to the presence of such hydroxyl groups.

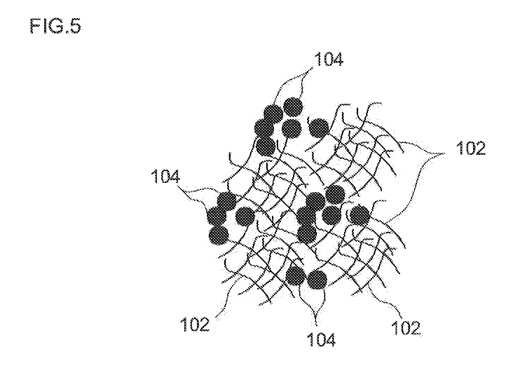

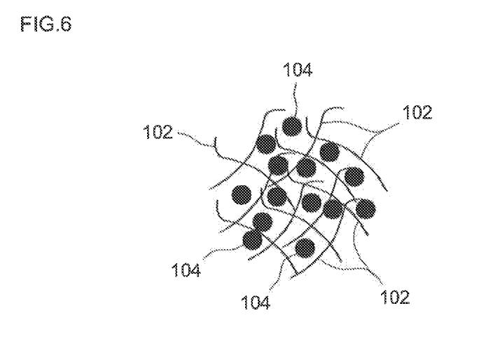

FIG. 5 is a schematic diagram illustrating the state obtained by adding a carbon source (for example, PVA) 102 together with a particulate electrode active material (for example, silicon oxide) 104 to the conventional single solvent (for example, water) and mixing. As shown in the diagram, where an individual solvent (for example, good solvent with respect to a carbon source) is used, excessive aggregation of electrode active material particles in this solvent can occur, which is undesirable for the above-described reasons. By contrast, when a method is used by which a carbon source supply material and electrode active material supply material are mixed by appropriate amounts by using a first solvent and a second solvent, as shown in FIG. 6, the carbon source 102 is present substantially only in a first solvent component. As a result, a presence distribution of the particulate electrode active material 104 is controlled according to a presence distribution of the carbon source 102 in a mixed material, aggregation such as shown in FIG. 5 is inhibited, and the advantageous dispersed state of the electrode active material (primary particle) 104 can be realized.

The mixing mass ratio of a carbon source supply material and electrode active material supply material can differ depending on the concentration of a carbon source and/or a content ratio of active material particles in the supply materials and, therefore, is not particularly limited.

As a guideline, it is preferred that the two supply materials be mixed so that a sufficient amount of a carbon source be applied to the surface of an electrode active material. For example, it is appropriate that a mixing ratio of a carbon source supply material and an electrode active material supply material be adjusted such that a carbon source (for example, PVA) be mixed in an amount of about 0.05 to 15 parts by weight per 1 part by weight of a particulate electrode active material (for example, silicon oxide). It is preferred that a mixed material be prepared by mixing the carbon source supply material and the electrode active material supply material so that a carbon source (for example, PVA) is mixed at about 0.1 to 10 parts by weight (for example, about 0.5 to 5 parts by weight or about 1 to 5 parts by weight) per 1 part by weight of the particulate electrode active material (for example, silicon oxide). By mixing a carbon source and a particulate electrode active material at such a mixing ratio, it is possible to apply an appropriate amount of the carbon source to the surface of the electrode active material.

As another indication, it is preferred that the two supply materials be mixed so as to prevent a particulate electrode active material from excessive aggregation. From this standpoint, it is desirable that a mixing volume ratio of a second solvent (for example, a polar organic solvent such as ethanol and other lower alcohols that allows a electrode active material particles such as SiOₓ to be dispersed therein), which is a poor solvent for a carbon source, be substantially equal to a mixing volume ratio of the first solvent (for example, water capable of dissolving a carbon source such as PVA), that is, that the two solvents be mixed in substantially equal volumes. For example, an appropriate mixing volume ratio of the first solvent and the second solvent (first solvent:second solvent) is 1:3 to 3:1, preferably 1:2 to 2:1, more preferably 1:1.5 to 1.5:1, and particularly preferably substantially 1:1.

By setting the mixing volume ratio of the first solvent and the second solvent as described hereinabove, it is possible to reduce an aggregation of electrode active material particles and form secondary particles (associations) of an electrode active material of a comparatively small diameter. In other words, by adjusting a mixing volume ratio of a first solvent and a second solvent, it is possible to adjust the diameter and size of electrode active material particles provided with a carbon coat (aggregates of the primary particles, that is, secondary particles) obtained after the calcination.

In yet another preferred embodiment of the manufacturing method disclosed herein, a reflux processing is performed by heating the mixed material to a temperature range at which a solvent of the mixed material (that is, a mixed solvent of a first solvent and second solvent) boils, after the two abovementioned supply materials are mixed and before a compound including phosphorus or boron is added to the obtained mixed material, with the object of further improving a dispersed state of a particulate electrode active material (electrode active material 104 such as shown in FIG. 5) in the mixed material.

For example, when the first solvent is water and the second solvent is ethanol (or other lower alcohol) which is a nonaqueous solvent compatible with water, it is preferred that a reflux processing be performed for an appropriate time, typically for about 1 to 24 hours (for example, 8 to 12 hours) in a temperature range (typically, 80 to 100° C., for example, about 90±5° C.) that exceeds about 73° C. which is an azeotropic temperature of ethanol and water. The reflux processing is by itself a well-known technique and since no special processing is required to carry out the present invention, further detailed explanation thereof is herein omitted.

In the manufacturing method disclosed herein, in order to form a conductive carbon coat in which carbon atoms are strongly bonded to each other on the surface of the electrode active material particles, a compound including phosphorus or boron, such as described hereinabove, is added to the abovementioned mixed material (a mixture of electrode active material and carbon source) after the reflux processing and before the below descried calcination. The amount of the compound to be added is preferably such as to enable complete dissolution in the mixed material and about such as to enable sufficient contact of phosphorus or boron with a carbon source in the mixed material. The amount of the compound including phosphorus or boron that is to be added is not particularly limited, but, for example, an appropriate amount is about 1 to 50 parts by weight, preferably 1 to 30 parts by weight, more preferably 5 to 30 parts by weight per 100 parts by weight of a carbon source (for example, PVA) contained in a mixed material that will be added.

In yet another preferred embodiment of the manufacturing method disclosed herein, when the compound including phosphorus or boron is added to the mixed material, the compound is provided at least in a form of a solution obtained by being dissolved in a liquid solvent compatible with the above-mentioned first solvent. Where the compound is added in the form of such a solution, the compound is more easily dissolved in the mixed material and phosphorus or boron contained in the compound more easily diffuse to obtain a uniform distribution than in the case where the compound is added in a solid form (for example, as a powder or lumps of a predetermined size). As a result the phosphorus or boron can uniformly come into contact with a carbon source (strictly speaking, a carbon source dissolved in the first solvent component) present in the mixed material. Phosphorus or boron that has come into contact with the carbon source acts upon the carbon source (for example, PVA) (for example, can demonstrate an effect of enabling the formation of new bonds of various kinds, for example, such as bonds similar to double bonds or bridge (crosslinking) bonds in molecules of the carbon source). As a result, a carbon coat with uniformly and evenly improved strength of carbon-carbon bonds can be formed on the surface of ectrode active material particles after the calcination of the mixed material.

A liquid medium for dissolving the compound including phosphorus or boron is not particularly limited, provided that the liquid medium is compatible with the first solvent, as mentioned hereinabove, but when the compound including phosphorus or boron is an inorganic phosphoric acid or inorganic boric acid, an aqueous solvent (typically, water) can be advantageously used. Further, the concentration of the compound including phosphorus or boron is not particularly limited, but taking into account that a mixed material is dried to remove a solvent after the addition of the compound and then calcined, it is preferred that a high-concentration solution of the compound be used in order to reduce the amount of the liquid medium that is added. For example, an appropriate concentration is equal to or higher than 80 wt %, and the preferred concentration is equal to or higher than 90 wt %. When, for example, orthophosphoric acid is used as the compound including phosphorus, an aqueous solution with a concentration, for example, equal to or higher than 85 wt % can be advantageously used. A solution prepared by dissolving crystal of orthophosphoric acid in water (ion-exchanged water or pure water) or a commercial product (for example, procured from Sigma-Aldrich CO.) may be used as an aqueous solution of orthophosphoric acid with such a concentration.

In one embodiment of the manufacturing method disclosed herein, after the compound including phosphorus or boron has been added (for example, in a form of a solution obtained by dissolving the compound in a predetermined liquid medium) to the mixed material, a solvent contained in the mixed material (that is, mainly a mixed solvent of a first solvent and second solvent that also includes a liquid medium used for dissolving the compound when the compound including phosphorus or boron is used as a solution) is evaporated. The evaporation can be performed by a typical method, for example, by using a rotary evaporator. In this way, it is possible to collect aggregates of the above-mentioned electrode active material and carbon source from which the solvent has been removed.

In order to inhibit more reliably an excessive aggregation of an electrode active material particles and also to obtain a composite (association) (that is, a composite that serves as a base for forming secondary particles constituted by an electrode active material provided with a carbon coat) of an electrode active material particles of smaller particle size and carbon source, a method may be used by which a mixed material after the addition of the compound including phosphorus or boron is added to a third solvent that is a solvent different from the second solvent, can disperse a particulate electrode active material and is a poor solvent with respect to a carbon source (typically, the mixed material is dropwise added to a third solvent). In such a case, it is possible to form a composite of a comparatively small size that is constituted by a carbon source and a particulate electrode active material. The collection of the composite can be performed by evaporating a third solvent during its boiling process. It is preferred that a third solvent have a boiling point that is still higher than that of a first solvent (typically, higher than that of a second solvent). Where a third solvent having such a boiling point is used, a first solvent can be removed before the third solvent. Therefore, the carbon source is not redissolved in a first solvent and, in their turn, the collapse of the associations and the re-aggregation of the particulate electrode active material can be prevented.

Various solvents can be used as a third solvent, provided that the above-mentioned conditions are satisfied. For example, when the abovementioned first solvent is an aqueous solvent (typically, water) and the aforementioned carbon source is a water-soluble compound (for example, PVA), it is preferred that an organic solvent that is compatible with the aqueous solvent and is unlikely to dissolve a water-soluble compound be used as the third solvent (poor solvent). For example, an aprotic polar solvent (for example, acetone or acetonitrile) that is unlikely to dissolve a water-soluble compound) can be advantageously used.

According to the manufacturing method disclosed herein, a mixture configured by the interaction of an electrode active material and a carbon source contained in a mixed material collected in the abovementioned manner (that is, a mixed material (a composite material constituted by an electrode active material and a carbon source) as referred to herein means a mixed material obtained by removing a solvent by evaporation after the addition of the compound including phosphorus or boron, or a mixed material from which the third solvent has been removed by evaporation in the case where the third solvent has been added after the addition of the compound including phosphorus or boron; the same meaning is implied hereinbelow), typically, a mixture configured by adhesion or bonding of a carbon source to the surface of an electrode active material particles, is calcined. As a result, it is possible to form on the surface of the electrode active material particles a conductive carbon coat that is derived from the carbon source (typically, an organic compound such as PVA), has an improved carbon-carbon bond strength due to the action of phosphorus or boron, and has good conductive paths.

The calcining conditions are not particularly limited provided that a carbon source which is used can be thermally decomposed and the surface of a particulate electrode active material can be coated with the thermal decomposition product. When a metal oxide such as silicon oxide represented by the abovementioned general formula SiOₓ is used as an electrode active material (in this case, a negative electrode active material), from the standpoint of preventing the calcining treatment from affecting structure or composition of an electrode active material, it is preferred that the calcination be conducted in an inert gas atmosphere such as argon gas and nitrogen gas. Further, the calcination may be conducted at any temperature, provided that a carbon source that is used can be thermally decomposed. The calcination is typically performed for about 3 to 12 hours (for example, 5 to 8 hours) at a temperature equal to or higher than 800° C. (for example, 800 to 1200° C., for example, 900 to 1000° C.). As a result, a carbon coat can be advantageously formed on the surface of a particulate electrode active material (primary particle). A material to be calcined is preferably subjected to pre-calcination for an appropriate time (typically, for 12 or less hours, for example, for about 1 to 6 hours) before the temperature is raised to the above-mentioned maximum temperature. It is preferred that the pre-calcination be performed in a temperature range typically of 100 to 600° C., for example, of 200 to 300° C., but this range is not particularly limited. By performing such a pre-calcination, it is possible to eliminate excessive reactive groups (for example, hydroxyl groups of PVA), for example, of a carbon source. Further, an effective calcined body can be obtained.

A particulate electrode active material provided with a carbon coat that is manufactured by the manufacturing method disclosed herein can be advantageously used, similarly to the conventional electrode active material, as an active material for a positive electrode or negative electrode of a battery. Secondary batteries of various types can be constructed by using the conventional materials and processes in addition to the feature of using such an electrode active material. For example, a lithium secondary battery can be constructed by using a metal oxide such as silicon oxide represented by the above-mentioned general formula SiOₓ that is provided with a carbon coat and manufactured by the manufacturing method disclosed herein as a negative electrode active material.

An embodiment of a lithium secondary battery provided with a negative electrode active material formed of silicon oxide represented by the general formula SiOₓ and manufactured by the manufacturing method disclosed herein is described below, but this embodiment is not intended to limit the utilization embodiment of an electrode active material disclosed herein.

A specific feature of the lithium secondary battery according to the present embodiment is that the abovementioned particulate electrode active material provided with the carbon coat is used as a negative electrode active material. Therefore, the contents, properties, and compositions of other materials and members constituting the battery are not particularly restricted and the materials and members similar to those of the conventional lithium secondary battery can be used, provided that the object of the present invention can be attained.

A configuration in which a negative electrode active material layer (also referred to as a negative electrode mix layer) is formed by causing the adhesion of a particulate negative electrode active material (SiOₓ) obtained by the manufacturing method disclosed herein together with a binder (binding material) and an optionally used conductive aid as a negative electrode mix to a negative electrode collector can be advantageously used as a negative electrode.

A rod-shaped body, a plate-shaped body, a foil-shaped body, or a mesh-shaped body constituted mainly by copper, nickel, titanium stainless steel, or the like can be used as a negative electrode collector. Examples of suitable binders include polyvinylidene fluoride (PVDF), polytetrafluoroethylene (PTFE), carboxymethyl cellulose (CMC), styrene butadiene rubber (SBR) and so on. Carbon materials such as the conventional carbon black can be advantageously used as a conductive aid.

Since a particulate negative electrode active material (primary particles) used herein is obtained by the manufacturing method disclosed herein, the surface thereof is sufficiently covered by a carbon coat and excels in electric conductivity. Therefore, a negative electrode active material layer may include no conductive aid or a content ratio of a conductive aid therein can be reduced with respect to that in the conventional negative electrode active material layers. The amount of a conductive aid related to 100 parts by weight of a negative electrode active material used can be, for example, about 1 to 30 parts by weight (preferably about 2 to 20 parts by weight, for example, about 5 to 10 parts by weight), but it is not limited thereto. A conductive aid may be introduced in advance into the above-described electrode active material supply material.

A powdered material including the abovementioned particulate negative electrode active material and optionally the conductive aid is dispersed together with an appropriate binder (binding material) in an appropriate dispersion medium (for example, an organic solvent such as N-methylpyrrolidone (NMP) or an aqueous solvent such as water) and kneaded to prepare a paste-like negative electrode mix (referred to hereinbelow as “negative electrode mix paste”). A negative electrode for a lithium secondary battery can be fabricated by coating an appropriate amount of the negative electrode mix paste on a negative electrode collector and then drying and pressing.

Meanwhile, a configuration in which an active material capable of reversibly absorbing and desorbing Li together with a binder and an optionally used conductive material are caused to adhere as a positive electrode mix to a collector can be advantageously used as a positive electrode.

A rod-shaped body, a plate-shaped body, a foil-shaped body, and a mesh-shaped body constituted mainly by aluminum, nickel, titanium, or stainless steel can be used as a positive electrode collector. A lithium-transition metal composite oxide having a layered structure, a lithium-transition metal composite oxide having a spinel structure, or a polyanion compound having an olivine structure, which can be used for a positive electrode of a typically lithium secondary battery, can be advantageously used as a positive electrode active material. Representative examples of such active materials include lithium-transition metal oxides such as lithium cobalt oxide (LiCoN, lithium nickel oxide (LiNiO₂), and lithium manganese oxide (LiMn₂O₄). Further, a compound represented by the following general formula: LiMAO₄ can be also used. In this formula, M is one, or two or more elements (typically, one, or two or more metal elements) including at least one metal element selected from the group consisting of Fe, Co, Ni, and Mn. Thus, at least one metal element selected from the group consisting of Fe, Co, Ni, and Mn is included, but the presence of minor additional elements that can be included in small amounts is also allowed (those minor additional elements may also not be present). Further, in the abovementioned formula, A is preferably one, or two or more elements selected from the group consisting of P, Si, S, and V. Specific examples include LiFePO₄, LiFeSiO₄, LiCoPO₄, LiCoSiO₄, LiFe_{0.5}Co_{0.5}PO₄, LiFe_{co}Co_{0.5}SiO₄, LiMnPO₄, LiMnSiO₄, LINiPO₄, and LiNiSiO₄ as particularly preferred polyanion compounds.

A binder can be same as that used on a negative electrode side. Examples of suitable conductive materials include carbon materials such as carbon black. (for example, acetylene black), a graphite powder and so on, or a conductive metal powder such as a nickel powder and so on. The amount of the conductive material related to 100 parts by weight of the positive electrode active material can be, for example, 1 to 20 parts by weight (preferably, 5 to 15 parts by weight), but those ranges are not limited. Further, the amount of a binder related to 100 parts by weight of a positive electrode active material can be, for example, 0.5 to 10 parts by weight.

A paste-like positive electrode mix (referred to hereinbelow as “positive electrode mix paste”) is prepared by dispersing a powdered material including the positive electrode active material and the conductive aid such as described hereinabove together with an appropriate binder in an appropriate dispersion medium and kneading, in the same manner as on a negative electrode side. A positive electrode for a lithium secondary battery can be fabricated by coating an appropriate amount of the positive electrode mix paste on a positive electrode collector and then drying and pressing.

A liquid electrolyte including a nonaqueous solvent and a lithium salt that can be dissolved in this solvent can be advantageously used as an electrolyte introduced between a positive electrode and a negative electrode. A solid (gelled) electrolyte obtained by adding a polymer to the aforementioned liquid electrolyte may be also used. Aprotic solvents such as carbonates, esters, ethers, nitriles, sulfones, and lactones can be used as the abovementioned nonaqueous solvent. For example, one, or two or more solvents selected from the nonaqueous solvents known to be typically suitable for electrolytes of lithium ion batteries can be used as the abovementioned nonaqueous solvent, specific examples of such solvents including ethylene carbonate (EC), propylene carbonate (PC), diethyl carbonate (DEC), dimethyl carbonate (DMC), ethyl methyl carbonate (EMC), 1,2-dimethoxyethane, 1,2-diethoxyethane, tetrahydrofuran, 2-methyl tetrahydrofuran, dioxane, 1,3-dioxolan, diethylene glycol dimethyl ether, ethylene glycol dimethyl ether, acetonitrile, propionitrile, nitromethane, N,N-dimethylformamide, dimethylsulfoxide, sulfolan, γ-butyrolactone, and so on.

One, or two or more salts selected from various lithium salts that are known to be capable of functioning as support electrolytes in electrolytic solution of lithium ion batteries can be used as the lithium salt, specific examples including LiPF₆, LiBF₄, LiN(SO₂CF₃)₂, LiN(SO₂C₂F₅)₂, LiCF₃SO₃, LiC₄F₉SO₃, LiC(SO₂CF₃₁₃, and LiClO₄. The concentration of a lithium salt is not particularly limited and can be same, for example, as that of the electrolyte used in the conventional lithium ion batteries. Usually, a nonaqueous electrolyte including about 0.1 mol/L to 5 mol/L (for example, about 0.8 mol/L to 1.5 mol/L) of support electrolyte (lithium salt) can be advantageously used.

A lithium secondary battery is constructed by accommodating the abovementioned positive electrode and negative electrode together with an electrolyte in an appropriate case (a housing made from a metal or a resin, a bag made from a laminated film, and the like). In a representative configuration of the lithium secondary battery disclosed herein, a separator is introduced between a positive electrode and a negative electrode. A separator similar to those used in typical lithium secondary batteries can be used, and no particular limitation is placed thereon. For example, a porous sheet, a nonwoven fabric or the like made of a resin such as polyethylene (PE), polypropylene (PP), polyesters, cellulose, and polyamides can be used. A lithium secondary battery using a solid electrolyte may be configured such that the electrolyte also functions as a separator. The shape (outer shape of the case) of a lithium secondary battery is not particularly limited, and the battery may have, for example, a cylindrical shape, an angular shape, a coin shape or the like.

A more specific embodiment of a lithium secondary battery using a negative electrode active material manufactured by the manufacturing method disclosed herein is explained below by way of examples of a lithium secondary battery provided with a wound electrode body and a battery pack for a vehicle that is constructed by using such a battery as a constituent part (unit cell), but the present invention is not intended to be limited by this embodiment.

In the figures described hereinbelow, members or parts demonstrating same operations may be assigned with same reference numerals and the redundant explanation thereof may be omitted or simplified. Further, the dimensional relationships (length, width, thickness, and the like) in the figures do not reflect the actual dimensional relationships.

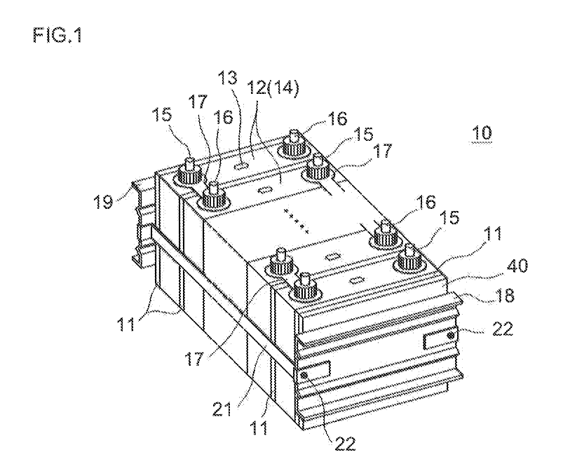

As shown in FIG. 1, similarly to unit cells provided in the conventional battery packs, a unit cell 12 used as a constituent element of a battery pack 10 according to the present embodiment typically comprises an electrode body having predetermined battery constituent materials (positive electrode active material, negative electrode active material, positive electrode collector, negative electrode collector, separator, and the like) and a case accommodating the electrode body and an appropriate electrolyte.

The battery pack 10 disclosed herein comprises a predetermined number (typically 10 or more, preferably about 10 to 30, for example, 20) unit cells 12 having the same shape. The unit cell 12 is provided with a case 14 of a shape (in the present embodiment, a flat box-like shape) that can accommodate the below-described flat-shaped wound electrode body. The dimension (for example, the external shape such as the thickness in the stacking direction) of parts of the unit cells 12 can be varied due to dimensional errors during the manufacture of the cases

The case 14 is provided with a positive electrode terminal 15 for electric connection to the positive electrode of the wound electrode body and a negative electrode terminal 16 for electric connection to the negative electrode of the electrode body. As shown in the figure, the positive electrode terminal 15 of one unit cell and the negative electrode terminal 16 of the other unit cell, among the adjacent unit cells 12, are electrically connected by a connection jig 17. The battery pack 10 designed for a desired voltage is thus constructed by connecting the unit cells 12 in series as described hereinabove.

A safety valve 13 or the like for releasing a gas generated inside the case can be provided in the case 14 in the same manner as in the conventional unit cell case. The configuration of the case 14 itself does not characterize the present invention and therefore the detailed explanation thereof is herein omitted.

The material of the case 14 is not particularly limited, provided that it is similar to that used in the conventional unit cells. For example, a case made from a metal (for example, aluminum, steel and so on) and a case made from a synthetic resin (for example, resins having high-melting point, e.g., a polyolefin resin such as polypropylene, polyethylene terephthalate, polytetrafluoroethylene, polyamide resins, and so on) can be advantageously used. The case 14 according to the present embodiment is made, for example, from aluminum.

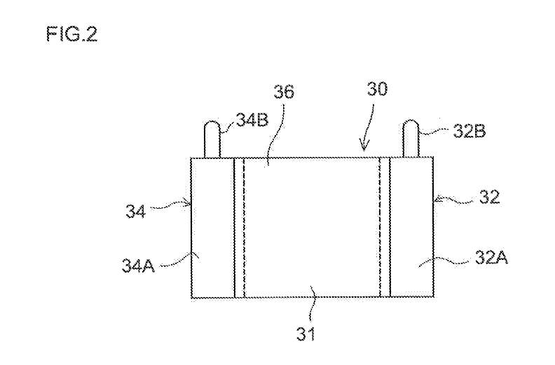

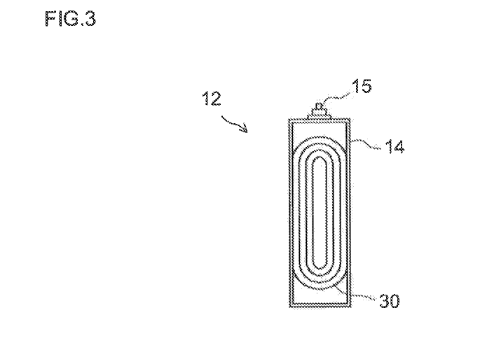

As shown in FIG. 2 and FIG. 3, similarly to the wound electrode body of the usual lithium ion battery, the unit cell 12 is provided with a flat-shaped wound electrode body 30 produced by laminating a sheet-shaped positive electrode 32 (also referred to hereinbelow as “positive electrode sheet 32”), a sheet-shaped negative electrode 34 (also referred to hereinbelow as “negative electrode sheet 34”) with a total of two sheet-shaped separators 36 (referred to hereinbelow as “separator sheet 36”), winding the positive electrode sheet 32 and the negative electrode sheet 34 with a certain displacement, and then deforming the obtained wound body by pressurization from the side surface direction.

As shown in FIG. 2 and FIG. 3, the winding is performed with a certain displacement, as mentioned hereinabove, in the direction crossing the winding direction of the wound electrode body 30. As a result, end portions of the positive electrode sheet 32 and the negative electrode sheet 34 protrude to the outside from the respective wound core portions 31 (that is, a portion where the positive electrode active material layer formation portion of the positive electrode sheet 32, the negative electrode active material layer formation portion of the negative electrode sheet 34, and the separator sheet 36 are thickly wound together). A positive electrode lead terminal 32B and a negative electrode lead terminal 34B are attached to the protruding portion 32A on the positive electrode side (that is, the non-formation portion of the positive electrode active material layer) and the protruding portion 34A on the negative electrode side (that is, the non-formation portion of the negative electrode active material layer), respectively, and those lead terminals 32B, 34B are electrically connected to the above-described positive electrode terminal 15 and negative electrode terminal 16, respectively.

The materials constituting the wound electrode body 30 of the above-described configuration and the members themselves are not particularly limited and may be same as those of the electrode body of the conventional lithium ion battery, except that a negative electrode active material (for example, represented by the abovementioned general formula SiOₓ) provided with a carbon coat and obtained by the manufacturing method disclosed herein is used.

The positive electrode sheet 32 is formed by attaching the positive electrode active material layer for a lithium secondary battery to an elongated positive electrode collector (for example, an elongated aluminum foil). In the present embodiment, a sheet-shaped positive electrode collector having a shape that can be advantageously used in the lithium secondary battery (unit cell) 12 provided with the wound electrode body 30 is used. For example, the positive electrode active material layer is formed by using an aluminum foil with a length of about 2 m to 4 in (for example, 2.7 m), a width of about 8 cm to 12 cm (for example, 10 cm), and a thickness of about 5 μm to 30 μm (for example, 10 μm to 20 μm) as the collector and coating the positive electrode mix paste that has been prepared in advance on the surface of the collector. The abovementioned paste can be advantageously applied to the surface of the positive electrode collector by using an appropriate application device such as a gravure coater, a slit coater, a die coater, a comma coater, or the like.

After the paste has been applied, as solvent (typically, water) contained in the paste is dried and compressed (pressurized) to form a positive electrode active material layer. The conventional well-known compression method such as a roll pressing method and a plate pressing method can be used as the compression method. When the thickness of the positive electrode active material layer is adjusted, the thickness may be measured with a film thickness meter and the compression may be performed a plurality of times by adjusting the pressing pressure to obtain the desired thickness.

Meanwhile, the negative electrode sheet 34 can be formed by attaching the negative electrode active material layer for a lithium secondary battery to an elongated negative electrode collector. A conductive member made of a metal with good electric conductivity, for example copper, can be used as a negative electrode collector. In the present embodiment, a sheet-shaped negative electrode collector having a shape that can be advantageously used in the lithium secondary battery (unit cell) 12 provided with the wound electrode body 30 is used. For example, the negative electrode sheet can be advantageously produced by using a copper foil with a length of about 2 m to 4 m (for example, 2.9 m), a width of about 8 cm to 12 cm (for example, 10 cm), and a thickness of about 5 μm to 30 μm (for example, 10 μm to 20 μm) as a negative electrode collector, applying a negative electrode mix paste (for example, including negative electrode active material 80 to 90 wt %, conductive aid 3 to 15 wt %, binder 3 to 10 wt %) prepared by adding a negative electrode active material, binding materials and so on to an appropriate solvent (water, an organic solvent, or mixed solvents thereof) and dispersing or dissolving to the surface of the negative electrode collector, drying, and compressing.

Further, a sheet formed of a porous polyolefin resin is an example of the separator sheet 36 that can be advantageously used between the positive and negative electrode sheets 32, 34. For example, a porous separator sheet made from a synthetic resin (for example, from a polyolefin such as polyethylene) that has a length of about 2 m to 4 m (for example, 3.1 m), a width of about 8 cm to 12 cm (for example, 11 cm), and a thickness of about 5 μm to 30 μm (for example, 25 μm) can be advantageously used.

In the case of a lithium secondary battery using a solid electrolyte or a gelled electrolyte as the electrode (the so-called lithium ion polymer battery), the separator is sometimes not required (thus, in this case, the electrolyte itself can function as the separator).

The unit cell 12 is constructed by accommodating the obtained flat-shape wound electrode body 30 inside the case 14 so that the winding axis is oriented sideways as shown in FIG. 3, pouring a nonaqueous electrolyte (liquid electrolyte) such as a mixed solvent of diethyl carbonate (DEC) and ethylene carbonate (EC) (the DEC:EC volume ratio can be within a range of 1:9 to 9:1) including an appropriate amount (for example, concentration 1 M) of an appropriate support salt (for example, a lithium salt such as LiPF₆ or the like) into the case, and sealing.

As shown in FIG. 1, a plurality of unit cells 12 of the same shape that have been constructed in the above-described manner are arranged so that the wide surfaces of the cases 14 (that is, the surfaces facing the flat surfaces of the below-described wound electrode bodies 30 accommodated inside the cases 14) face each other, while every other unit cell is being reversed so that the positive electrode terminals 15 and the negative electrode terminals 16 thereof are arranged alternately. Cooling plates 11 of a predetermined shape are disposed so as to be in intimate contact with wide surfaces of the cases 14 between the arranged unit cells 12 and on both outer sides in the unit cell arrangement direction (stacking direction). The cooling plates 11 function as heat dissipating members for efficiently dissipating the heat generated inside the unit cells when the unit cells are used. It is preferred that the cooling plates have a frame-like shape such that a cooling fluid (typically, air) could be introduced between the unit cells 12. Alternatively, cooling plates 11 made from a metal with good thermal conductivity or from lightweight and hard polypropylene or other synthetic resin can be advantageously used.

A pair of end plates 18, 19 is disposed further on the outside of the cooling plates 11 arranged on both outer sides of the unit cells 12 and the cooling plates 11 arranged in the above-described manner (the combination thereof will be referred to hereinbelow as “unit cell group”). One or a plurality of sheet-shaped spacer members 40 serving as length adjusting means may be inserted between the cooling plate 11 disposed on one outer side (right side in FIG. 2) of the abovementioned unit cell group and the end plate 18. The material constituting the spacer member 40 is not particularly limited, and a variety of materials (metal materials, resin materials, ceramic materials, and the like) can be used, provided that the below described length adjusting function can be demonstrated. From the standpoint of durability against shocks etc., it is preferred that a metal material or a resin material be used. For example, the spacer member 40 made for a lightweight polyolefin resin can be advantageously used.

Further, the entire body including the unit cell group in which the unit cells 12 are thus arranged in the stacking direction, the spacer member 40, and the end plates 18, 19 is then restrained by a predetermined restraining pressure P in the stacking direction by using a restraining band 21 for fastening that is attached so as to span between the two end plates 18, 19. More specifically, as shown in FIG. 1, the end portions of the restraining band 21 are fastened and fixed to the end plate 18 by screws 22, thereby restraining the unit cell group so that a predetermined restraining pressure P (for example, the surface pressure received by the wall surface of the cases 14 is about 0.1 MPa to 10 MPa) is applied in the unit cell arrangement direction. In the battery pack 10 restrained by such a restraining pressure P, the restraining pressure is also applied to the wound electrode body 30 located inside the case 14 of each unit cell 12, and the gas generated inside the cases 14 can be prevented from accumulating inside the wound electrode body 30 (for example, between the positive electrode sheet 32 and the negative electrode sheet 34) and degrading the battery performance.

In several specific examples, the lithium secondary batteries (sample batteries) were constructed by using the negative electrodes provided with the particulate negative electrode active material (silicon oxide) manufactured by the manufacturing method disclosed herein, and the performance of the sample batteries was evaluated.

<Preparation of Sample 1>

A carbon source supply material was prepared by adding 12 g of polyvinyl alcohol (PVA) as a carbon source to 150 mL of pure water as the first solvent, and stirring for 1 hour by using a stirrer under ultrasonic irradiation.

Then, commercial silicon monoxide (SiO: manufactured by Sigma-Aldrich Co.) and a carbon black (CB) powder were placed into a planetary ball mill to obtain a mass ratio of SiO:CB=10:1, and a grinding-mixing processing was per formed for 3 hours at 250 rpm.

The powdered material including silicon monoxide having an average particle size (median diameter based on a light scattering method: d50) of about 400 nm that was obtained by the abovementioned ball mill processing was weighted to obtain a silicon monoxide weight of 12 g and added to 150 mL of ethanol. An electrode active material supply material in a state with dispersed silicon monoxide was then prepared by stirring for 1 hour by using a stirrer under ultrasonic irradiation.

The abovementioned prepared electrode active material supply material (second solvent: ethanol) was then added to the prepared carbon source supply material (first solvent; pure water), while stirring with a stirrer under ultrasonic irradiation.

The mixed material obtained in the above-described manner, that is, the mixed material including 12 g of SiO, 12 g of PVA, and 1.2 g of CB and comprising a mixed solvent of 150 mL of pure water and 1.50 mL of ethanol (the volume ratio of water to ethanol is 1:1) is subjected to a reflux processing for 12 hours at 90° C.

A total of 100 mL of the mixed material after the reflux processing was sampled. A commercial aqueous solution (concentration 85 wt %; product of Sigma-Aldrich Co.) of orthophosphoric acid (H₃PO₄) was then prepared, the aqueous H₃PO₄ solution was weighted so that the mass of H₃PO₄ to be included corresponded to 1 wt % of the INA mass (that is, 4 g) contained in 100 mL of the mixed material, and the weighted amount was added to the abovementioned mixed material. The mixture (mixed material after the aqueous H₃PO₄ solution has been added) was then heated to 85° C., and a residue was obtained by evaporating the solvent. The residue was taken as Sample 1.

<Preparation of Sample 2>

An aqueous H₃PO₄ solution weighted so that H₃PO₄ was included in an amount corresponding to 5 wt % of the PVA weight was added instead of adding the aqueous H₃PO₄ solution including H₃M in an amount corresponding to 1 wt % of the PVA weight as in the above-described method for preparing Sample 1. With the exception of this process. Sample 2 was prepared in the same manner as the abovementioned Sample 1.

<Preparation of Sample 3>

An aqueous H₃PO₄ solution weighted so that H₃PO₄ was included in an amount corresponding to 10 wt % of the PVA weight was added instead of adding the aqueous H₃PO₄ solution including H₃PO₄ in an amount corresponding to 1 wt % of the PVA weight as in the above-described method for preparing Sample 1. With the exception of this process, Sample 3 was prepared in the same manner as the abovementioned Sample 1,

<Preparation of Sample 4>

An aqueous H₃PO₄ solution weighted so that H₃PO₄ was included in an amount corresponding to 20 wt % of the PVA weight was added instead of adding the aqueous H₃PO₄ solution including H₃PO₄ in an amount corresponding to 1 wt % of the PVA weight as in the above-described method for preparing Sample 1. With the exception of this process, Sample 4 was prepared in the same manner as the abovementioned Sample 1.

<Preparation of Sample 5>

Sample 5 was prepared as a reference sample in the same manner as the abovementioned Sample I, except that no aqueous H₃PO₄ solution was added, instead of adding the aqueous H₃PO₄ solution including H₃PO₄ in an amount corresponding to 1 wt % of the PVA weight as in the above-described method for preparing Sample 1.

(Construction of Evaluation Cells and Evaluation of Electrochemical Characteristics)

Evaluation cells were fabricated by using the abovementioned Samples 1 to 5.

Thus, the maximum calcination temperature was set for each sample to about 1000° C. and the calcination was performed for about 6 hours at this temperature in an argon gas atmosphere. After the samples had been subjected to pre-calcination in advance for about 1 to 5 hours within a temperature range of 200 to 300° C., the temperature was raised to the maximum calcination temperature. As a result, the unnecessary hydroxyl groups of PVA could be eliminated.

The ratio (content ratio; wt %) of the amount of carbon contained in Sample 1 to the total weight of Sample 1 was determined in the below-described manner for Sample 1 after the calcination.

Thus, thermal gravimetry and differential thermal analysis (TG-DTA) were performed on Sample 1 in the air. TG-DTA of SiO as a blank was also performed. The weight reduction amount of Sample 1 was determined from the TG-DTA results and the ratio of carbon amount to the total weight of Sample 1 was calculated on the basis of the weight reduction amount.

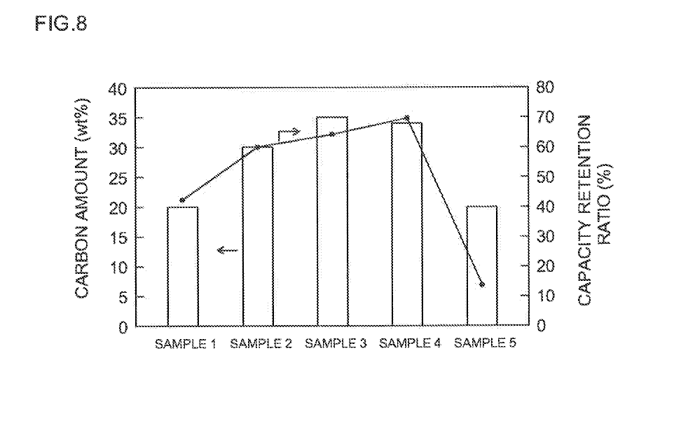

The ratio of carbon amount to the total weight of Samples 2 to 5 was determined in the same manner. The results are shorn in Table 1 and FIG. 8.

As shown in Table 1, in Sample 2 that included H₃PO₄ at a ratio of 5 wt % of the PVA weight, the ratio of carbon amount contained in the sample (that is, the content ratio) was 30 wt % and about the same as in Sample 5 that was a reference example containing no H₃PO₄. Further, in Samples 3 and 4 that included H₃PO₄ at a ratio of 10 wt % and 20 wt % of the PVA weight, the aforementioned ratio of carbon amount exceeded 30 wt %.

Electrode active materials for testing were obtained by grinding obtained calcined Samples 1 to 5, respectively, and classifying with a 100-mesh sieve. Test electrodes were fabricated by using the obtained 100-mesh-under electrode active material particles. Thus, the active material, a graphite powder and PVDF were mixed with N-methyl pyrrolidone to obtain a mixing ratio thereof of 85:10:5 and a slurry composition (paste) was thus prepared. The composition was applied on a copper foil (manufactured by Nippon Foil Mfg. Co., Ltd.) with a thickness of 10 μm and dried, thereby forming an active material layer with a thickness of 25 μm on one side of the copper foil. Then, a test electrode was then fabricated by pressing to obtain the electrode density of 1.2 mg/cm² of the entire body including the copper foil and the active material layer, and then punching to obtain a circle with a diameter of 16 mm.

A metallic lithium foil with a diameter of 15 mm and a thickness of 0.15 mm was used as a counter electrode. A porous polyolefin sheet with a diameter of 22 mm and a thickness of 0.02 mm was used as a separator. A solution prepared by dissolving LiPF₆ as a lithium salt to a concentration of about 1 mol/L in a mixed solvent including ethylene carbonate (EC) and diethyl carbonate (DEC) at a volume ratio of 3:7 was used as a liquid electrolyte.

The aforementioned constituent elements were incorporated into a stainless steel case, thereby constructing an evaluation coin cell of a typical shape with a thickness of 2 mm and a diameter of 32 mm (the so-called 2032 type).

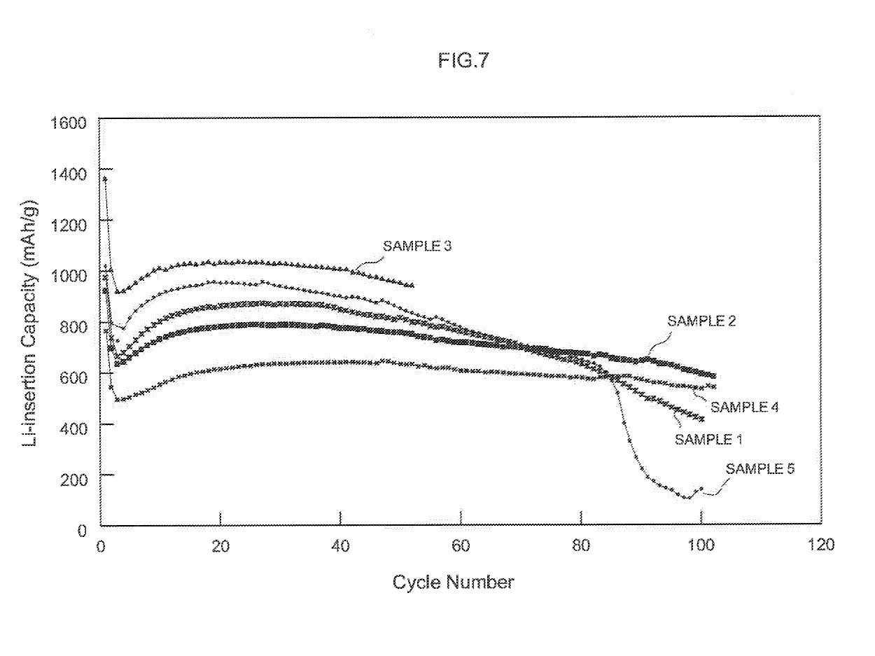

Among the coin cells of five types fabricated for each of the above-mentioned samples (the cell fabricated by using the electrode active material of Sample 1 will be referred to hereinbelow as “cell of Sample 1”; likewise for Samples 2 to 5), a cycle test was implemented with respect to each cell of Samples 1 to 5 by performing the operation of introducing Li into the test electrode to obtain an inter-electrode voltage of 0.01 V at a constant current of 0.1 C (a current value obtained by multiplying 1 C, that is, the current value enabling full charging for 1 h, by 0.1) and the operation of causing the desorption of Li to obtain an inter-electrode voltage of 1.2 V at a constant current of 0.1 C. The cycle test implemented on the cell of Sample I included 100 cycles. The ratio obtained by dividing the Li insertion capacity in this case by the active material weight (the Li insertion capacity per unit weight of the active material: mAh/g) was determined for each cycle. The results are shown in FIG. 7.

The cycle tests on the cells of Samples 2 to 5 were also implemented up to 100 cycles in the same manner as the cycle test of the cell of Sample 1, and a Li insertion capacity per unit weight of the active material in each cycle was determined. The results are shown in FIG. 7. The cycle test on the cell of Sample 3 was implemented up to 50 cycles in the same process as that for the cell of Sample 1, and a Li insertion capacity per unit weight of the active material in each cycle was determined. The results are shown in FIG. 7.

The cycle characteristic (capacity retention ratio) of each cell of Samples 1 to 5 was then investigated. More specifically, in the cycle tests of the cells of Samples 1, 2, 4, and 5, the ratio of Li desorption capacity in the 100-th cycle to the Li insertion capacity in the 1st cycle was measured as a capacity retention ratio (%).

More specifically, the capacity retention ratio was determined by the following formula: (Li desorption capacity in the 100-th cycle)/(Li insertion capacity in the 1st cycle)×100. The results are shown in Table 1 and FIG. 8. Concerning the cycle characteristic (capacity retention ratio) of the cell of Sample 3, the ratio of the Li desorption capacity in the 50-th cycle to the Li insertion capacity in the 1st cycle in the cycle test was measured as a capacity retention ratio (%). The results are shown in Table 1 and FIG. 8.

TABLE 1

| Sample No. | 1 | 2 | 3 | 4 | 5 |
|---|---|---|---|---|---|
| Amount of added P | 1 wt % | 5 wt % | 10 wt % | 20 wt % | None |
| Carbon amount (wt %) | 20 | 30 | 35 | 34 | 30 |
| Capacity retention | 42.3 | 60.0 | 64.3 | 69.7 | 13.7 |
| ratio (%) | | | | | |

The above-described test results indicate that the cells (cells of Samples 1 to 4) using the electrode active materials of Samples 1 to 4 manufactured by the manufacturing method disclosed herein could realize a capacity retention ratio higher than the capacity retention ratio (13.7%) of the cell of Sample 5, which was the reference sample. In particular, the capacity retention ratio (42.3%) of the cell of Sample 1 in which H₃PO₄ was added at 1 wt % of PVA exceeded that of Sample 5, and it was confined that even the addition of H₃PO₄ in this amount could improve the endurance (cycle characteristic) of the cell. Further, a capacity retention ratio equal to or higher than 60% was demonstrated in all of the cells of Samples 2, and 4 in which H₃PO₄ was added at a ratio of 5 wt % or more of PVA, and a capacity retention ratio sufficiently higher than that of Sample 5 could be realized.

Furthermore, although Sample 2 in which H₃PO₄ was added at a ratio of 5 wt % of PVA and Sample 5, which was a reference sample, had about the same (30 wt %) amount (content ratio) of carbon and therefore the amount of carbon was the same, the cell provided with the active material constituted by the mixed material having H₃PO₄ added thereto was confirmed to have superior durability (cycle characteristic).

<Preparation of Sample 6>

Examples in which a compound including boron (B) instead of phosphorus (P) was added to the above-described prepared mixed materials are described below.

More specifically, an aqueous H₃BO₃ solution weighted so as to include commercial boric acid (H₃BO₃) in an amount corresponding to 10 wt % of the weight of PVA contained in the mixed material was added instead of adding the aqueous solution of orthophoshoric acid (H₃PO₄) as in the above-described method for preparing Sample 1. Sample 6 was prepared by the same method as for Sample 1, except for the aforementioned step.

<Preparation of Sample 7>

Sample 7 was prepared as a reference sample for Sample 6 by the same method as was used to prepare Sample 6, except that no aqueous solution of H₃BO₃ was added in the method for preparing Sample 6.

(Construction of Evaluation Cells and Evaluation of Electrochemical Characteristics)

Evaluation cells (coin cells) were constructed by using Samples 6 and 7 by the same procedure as that used to construct the evaluation cells by using Samples 1 to 5.

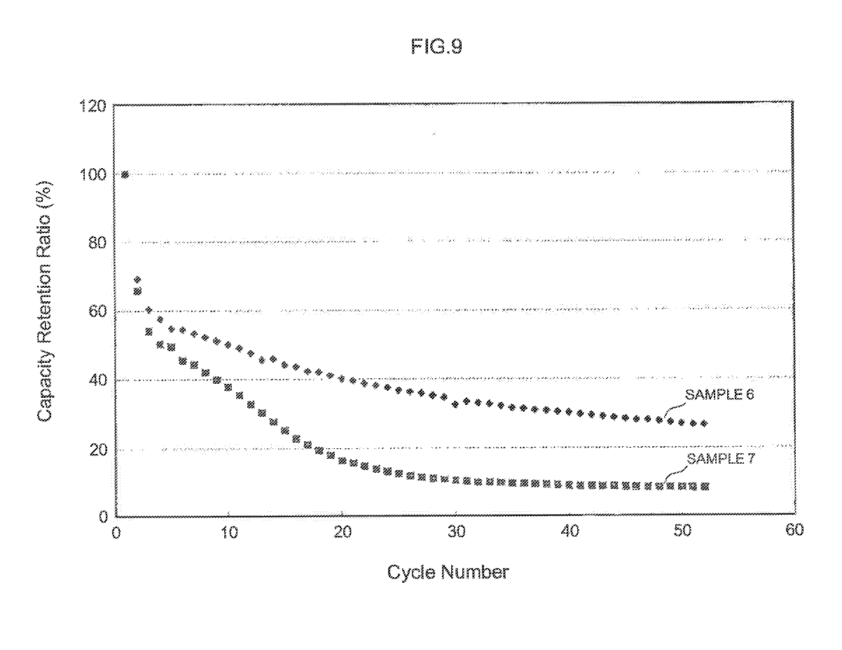

The cycle test was then implemented with respect to the coin cells of two types that were constructed by using Sample 6 or Sample 7, in the same manner as in the case where the evaluation cells (coin cells) were used that were constructed by using the above-described Samples 1 to 5, and the capacity retention ratio (%) of each cell was measured. In this case, the cycle test included 52 cycles. The capacity retention ratio (%) in each cycle is shown in FIG. 9 and the capacity retention ratio (%) of the last cycle (52nd cycle) is shown in Table 2 as the results obtained.

TABLE 2

| Sample No. | 6 | 7 |
|---|---|---|
| Amount of B added | 10 wt % | None |
| Capacity retention ratio (%) | 26.6 | 8.2 |

As shown in FIG. 9 and Table 2, in the cell of Sample 6, it was possible to realize the capacity retention ratio (%) higher than that of the cell of Sample 7, which was a reference sample. Thus, it was confirmed that the mixed materials having H₃BO₃ added thereto also can be used as active materials with improved capacity retention ratio (that is, cycle characteristic) of the cells. In other words, by adding a compound including boron to the mixed material, it is possible to obtain the same effect as that obtained when a compound including phosphorus is added to the mixed material.

The present invention is explained hereinabove on the basis of the preferred embodiments thereof, but this description is not limited, and it goes without saying that various modifications are possible.

Any of the lithium secondary batteries 12 and battery packs 10 disclosed herein excels in performance suitable for a battery to be installed on a vehicle, in particularly a high capacity retention ratio and durability. Further, an increase in capacity can be realized by using a metal oxide such as SiO, as an electrode active material.

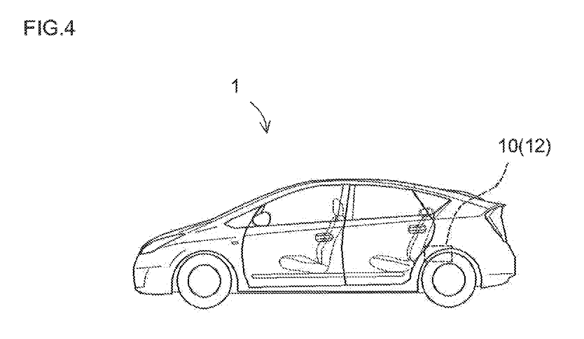

Therefore, in accordance with the present invention, as shown in FIG. 4, it is possible to provide a vehicle 1 provided with any of the lithium secondary batteries 12 (battery pack 10) disclosed herein. In particular, it is possible to provide a vehicle (for example, an automobile) in which the lithium secondary battery 12 serves as a power source (typically, a power source for a hybrid vehicle or an electric vehicle).

### INDUSTRIAL APPLICABILITY

With the manufacturing method disclosed herein, it is possible to provide an electrode active material that excels in a capacity retention ratio (that is, a cycle characteristic) and can realize increased capacity. Therefore, by using such an electrode active material, it is possible to provide a secondary battery such as a lithium secondary battery with a high capacity and good durability. Because of such features, by using the electrode active material manufactured by the manufacturing method disclosed herein, it is possible to provide a secondary battery for a vehicle (in particular, a lithium secondary battery for a vehicle) that can be used, for example, as a power source for driving the vehicle.

### REFERENCE SIGNS LIST

1 vehicle
10 battery pack
12 lithium secondary battery (unit cell)
15 positive electrode terminal
16 negative electrode terminal
30 wound electrode body
32 positive electrode sheet
34 negative electrode sheet
102 carbon source
104 electrode active material

1. A method for manufacturing a particulate electrode active material having a surface covered with a conductive carbon coat, the method comprising:
preparing a carbon source supply material prepared by dissolving a carbon source for forming the carbon coat in a predetermined first solvent in which the particulate electrode active material subject to coating can be dispersed;
preparing an electrode active material supply material prepared by dispersing the particulate electrode active material subject to coating in a second solvent that is compatible with the first solvent, that allows the particulate electrode active material to be dispersed therein, and that is a poor solvent with respect to the carbon source;
preparing a mixed material in which the prepared carbon source supply material and electrode active material supply material are mixed;
adding a compound comprising phosphorus (P) or boron (B) to the prepared mixed material; and
forming a conductive carbon coat derived from the carbon source on a surface of the electrode active material by calcining a mixture of the particulate electrode active material and the carbon source obtained after the addition.

2. The manufacturing method according to claim 1, wherein when the compound comprising phosphorus or boron is added to the mixed material, the compound is provided at least in a form of a solution obtained by being dissolved in a liquid medium compatible with the first solvent.

3. The manufacturing method according to claim 1, wherein at least one of inorganic phosphoric acids is used as the compound comprising phosphorus.

4. The manufacturing method according to claim 1, wherein at least one of inorganic boric acids is used as the compound comprising boron.

5. The manufacturing method according to claim 1, wherein the electrode active material is mainly formed of a silicon oxide represented by a general formula SiOₓ (x in the formula is a real number satisfying the condition 0<x<2).

6. The manufacturing method according to claim 1, wherein the carbon source is a water-soluble compound, the first solvent is an aqueous solvent, and the second solvent is a nonaqueous solvent that is compatible with water.

7. The manufacturing method according to claim 1, further comprising:
performing reflux processing of the mixed material before the compound comprising phosphorus or boron is added.

8. An electrode active material manufactured by the manufacturing method according to claim 1.

9. A lithium secondary battery comprising the electrode active material according to claim 8 in a positive electrode or a negative electrode.

10. A vehicle comprising the lithium secondary battery according to claim 9.
